(19) United States
(12) Patent Application Publication
(10) Pub. No.: US 2018/0151182 A1
(43) Pub. Date: May 31, 2018

(54) SYSTEM AND METHOD FOR MULTI-FACTOR AUTHENTICATION USING VOICE BIOMETRIC VERIFICATION

(71) Applicant: Interactive Intelligence Group, Inc., Indianapolis, IN (US)

(72) Inventors: Felix Immanuel Wyss, Zionsville, IN (US); Nicholas M. Luthy, Noblesville, IN (US)

(21) Appl. No.: 15/363,884

(22) Filed: Nov. 29, 2016

(51) Int. Cl. G10L 17/24; G06F 3/0481; G10L 17/02; G10L 17/06; G06F 21/32

(52) U.S. Cl. CPC G10L 17/24; G06F 3/0481; G06F 21/32; G10L 17/06; G10L 17/02

(57) ABSTRACT

A system and method are presented for multi-factor authentication using voice biometric verification. When a user requests access to a system or application, voice identification may be triggered. An auditory connection is initiated with the user where the user may be prompted to speak the current value of their multi-factor authentication token. The captured voice of the user speaking is concurrently fed into an automatic speech recognition engine and a voice biometric verification engine. The automatic speech recognition system recognizes the digit sequence to verify that the user is in possession of the token and the voice biometric engine verifies that the speaker is the person claiming to be the user requesting access. The user is then granted access to the system or application once they have been verified.

### BACKGROUND

The present invention generally relates to information security systems and methods, as well as voice biometric verification and speech recognition. More particularly, the present invention pertains to the authentication of users.

### SUMMARY

A system and method are presented for multi-factor authentication using voice biometric verification. When a user requests access to a system or application, voice identification may be triggered. An auditory connection is initiated with the user where the user may be prompted to speak the current value of their multi-factor authentication token. The captured voice of the user speaking is concurrently fed into an automatic speech recognition engine and a voice biometric verification engine. The automatic speech recognition system recognizes the digit sequence to verify that the user is in possession of the token and the voice biometric engine verifies that the speaker is the person claiming to be the user requesting access. The user is then granted access to the system or application once they have been verified.

In one embodiment, a method is presented for allowing a user access to a system through multi-factor authentication applying a voice biometric engine and an automatic speech recognition engine, the method comprising the steps of: accessing, by the user, the software application through a first device, wherein the accessing triggers voice identification of the user; initiating, by the system, an auditory interaction with the user; prompting, by the system, the user to speak the current value generated by a security token, wherein the generated current value is accessed by the user from a second device; capturing, by the system, voice of the user and feeding the voice into the automatic speech recognition engine and the voice biometric verification engine; and allowing access to the software application if the user's identity is verified, otherwise denying access to the user.

In another embodiment, a method is presented for allowing a user access to a system through multi-factor authentication using voice biometrics, the method comprising the steps of: accessing, by the user, the software application through a device, wherein the accessing triggers voice identification of the user; initiating, by the system, an auditory interaction with the user; prompting, by the system, the user to speak a first desired phrase; prompting by the system, the user to speak a second desired phrase; capturing, by the system, voice of the user and concurrently feeding the voice into a automatic speech recognition engine and a voice biometric verification engine; and allowing access to the software application if the user's identity is verified, otherwise denying access to the user.

### BRIEF DESCRIPTION OF THE DRAWINGS

FIG. 1 is a diagram illustrating an embodiment of system protected with a multi-factor authentication token.

FIG. 2 is a flowchart illustrating a process for voice-biometric verification of a user.

FIG. 3 is a diagram illustrating an embodiment of a system protected with voice biometric verification.

FIG. 4 is a diagram illustrating an embodiment of a system protected with voice biometric verification.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

In general, the most common form of authentication to control access to a computer system or software application uses a user identifier in combination with a secret password or passphrase. The user identifier may be derived from the user's name or their e-mail address. The user identifier is not considered secret thus security relies on the password remaining a secret. Users are prone to using the same password at multiple services. Further, users will not choose sufficiently long passwords with high entropy, which makes the passwords vulnerable through brute-force trials and dictionary attacks.

Additional factors may be added to increase security to a system or application, such as challenge questions or cryptographic security tokens in the user's possession. Examples of such security tokens might comprise RSA SecurID or Google Authenticator. These hardware tokens (e.g., key fobs) or software tokens generate a new six-digit number that changes at regular time intervals. The generated digit sequences are derived cryptographically from the current time and a secret key unique to each token and known to the authenticating system. By providing the correct value at login, the user claiming their identity proves with very high likelihood that they are in possession of the token that generated the current digit sequence.

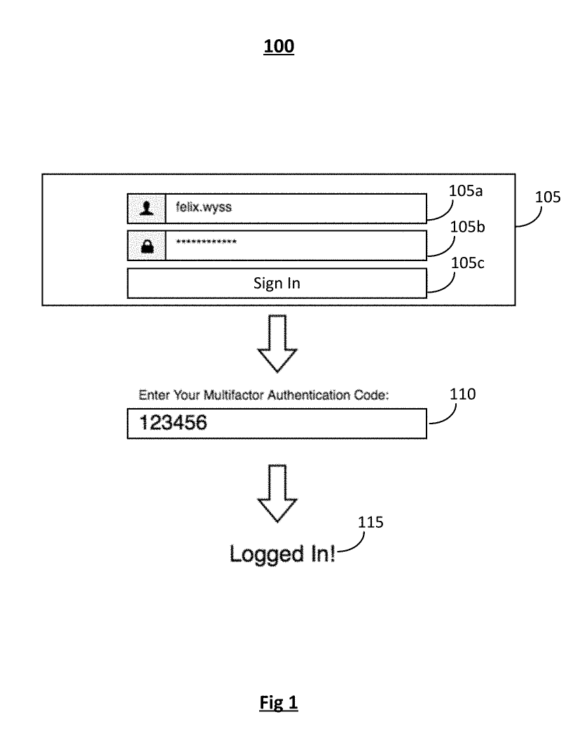

FIG. 1 illustrates an embodiment of system protected with a multi-factor authentication token, indicated generally at 100. At sign-in, a user may be presented with a window 105 in a user interface comprising a space for entering a userID 105a, a space for entering a passphrase 105b, and a sign-in button 105c. The user enters their user ID into the space at 105a, which in this example is ‘felix.wyss’. User ‘felix.wyss’ then enters a passphrase into the space 105b, which may be hidden from view. The user then clicks “sign-in” at 105c. The system then takes the user to a screen prompt to enter a multi-factor authentication code 110. The user accesses their authentication code from a device, such as a key fob or a smartphone, or an application on another device and enters the authentication code. The system verifies the code and the user is then logged in 115.

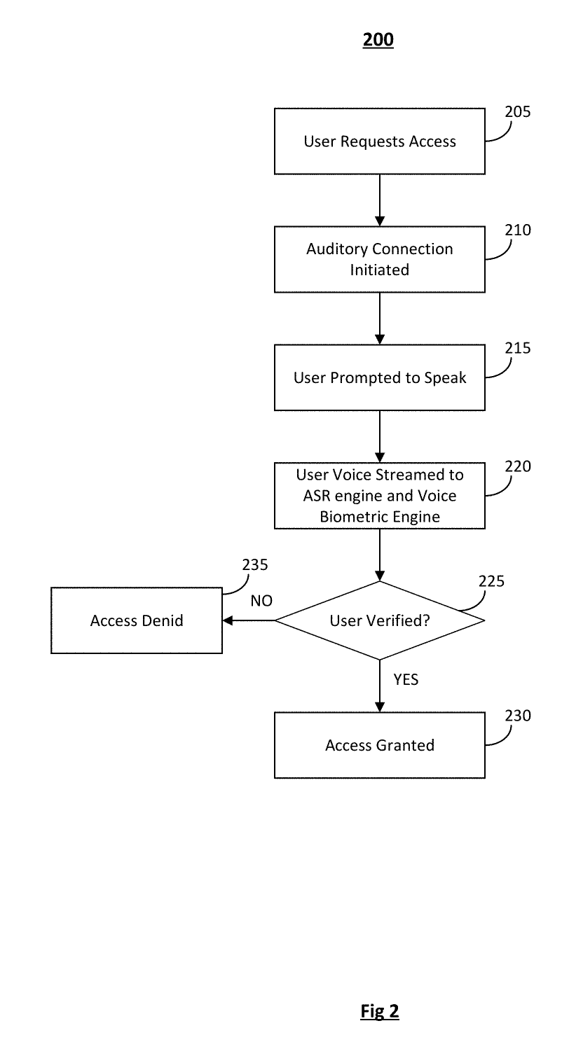

In an embodiment, the process for multi-factor authentication may be enhanced with voice-biometric verification of the user. Instead of using a password as a factor for authentication, the voice of the user may be verified using voice-biometric verification as a factor for authentication. FIG. 2 is a flowchart illustrating a process for voice-biometric verification of a user, indicated generally at 200.

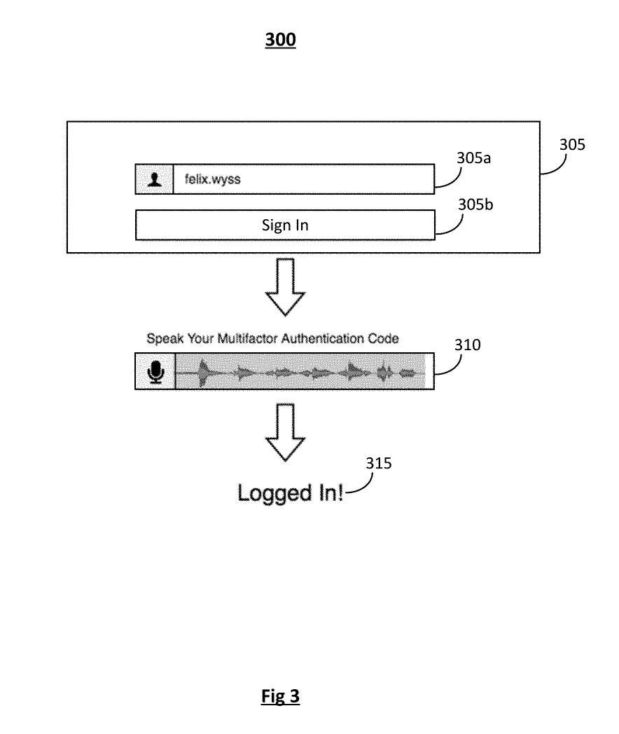

In operation 205, a user requests access. For example, the user may be requesting access to a computer system or to a software application through a user interface on a computing or mobile device. At sign-in, a user may be presented with a window comprising at least a space where the user may enter their userID, such exemplified in FIG. 3, which is described in greater detail below. When the user requests access, which may be through a sign-in request, the system triggers voice identification. In an embodiment, a user may also enter a passphrase in conjunction with their userID as an additional factor for authentication. Control is passed to operation 210 and the process 200 continues.

In operation 210, an auditory connection is initiated. For example, the system initiates an auditory connection with the user. In an embodiment, the connection may be made by leveraging a built-in microphone supported by the device being used by the user. In another embodiment, the connection may be made by the system initiating a telephone call to the user using a previously registered phone number associated with the user account. The connection needs to be capable of supporting voice from the user to verify the user. Control is passed to operation 215 and the process 200 continues.

In operation 215, the user is prompted to speak. For example, the system may prompt the user to speak the current value of their security token, or multi-factor authentication token. The prompt may be audible or visual. For example, the user may see an indication on the display of their device indicating them to speak. The system may also provide an audio prompt to the user. Control is passed to operation 220 and the process 200 continues.

In operation 220, the user's voice is streamed. For example, the system captures the voice of the user as they are speaking the current token value. The token may be a cryptographic token value. The captured voice of the user is concurrently fed into an automatic speech recognition (ASR) engine and a voice biometric verification engine. In another embodiment, the user's utterance may be captured in the browser/client device and submitted to the server in a request. Control is passed to operation 225 and the process 200 continues.

In operation 225, it is determined whether the user is verified. If it is determined that the user is verified, control is passed to operation 230 and the user is granted access. If it is determined that the user is not verified, control is passed to operation 235 and the user is denied access.

The determination in operation 225 may be based on any suitable criteria. For example, the ASR engine recognizes the digit sequence of the token to verify that the user is in possession of the token. The voice biometric engine verifies that the speaker is the person claiming to be the user requesting access. By asking the user to speak the multi-factor authentication token value, the ASR engine can capture the token value for verification. The voice biometric authentication engine is capable of verifying the spoken utterance belongs to the user and confirm identity. Verification by the ASR engine and the voice biometric authentication engine may be triggered when the confidence level of an engine reaches a threshold. The user is thus able to prove that they are in possession of the multi-factor authentication token while the user's claimed identity is verified through their voice print.

In operation 230, access is granted and the process 200 ends.

In operation 235, access is denied and the process 200 ends.

FIG. 3 illustrates a diagram of an embodiment of a system protected with voice biometric verification as part of multi-factor authentication, indicated generally at 300. At sign-in, a user may be presented with a window 305 in a user interface comprising a space for entering a userID 305a and a sign-in button 310b. In an embodiment, a space for entering a passphrase in addition to the userID may also be present. The user enters their userID into the space at 305a, which in this example is ‘felix.wyss”. The user clicks “sign-in” at 305b. The system then takes the user to a screen prompt for speaking a multi-factor authentication code 310. The user accesses the digits of the multi-factor authentication code from a device, such as a smartphone or an application on another device, and speaks the digits to the system. The system verifies the user's identity through the process 200 described in FIG. 2, and the verified user is then logged in 315.

A “replay attack” may be prevented through using the embodiments described in process 200. A person using their voice when interacting with others can be easily recorded by bystanders, which makes text-dependent single-phrase voice authentication solutions problematic. For example, a user speaking a hard-coded pass-phrase, such as “I'm Felix Wyss, my voice is my password”, is vulnerable to recording by a bystander who can play it back at a later time to system, impersonating the user. While some systems might try to counter this by keeping a history of utterances by the user and comparing them for similarity, recordings may be distorted so that the similarity threshold is not met, but the voice print still matches. Using a random digit sequence for voice verification makes replay attacks much more difficult as an attacker must have a recording of the user speaking all ten digits at least once, the user's multi-factor authentication token, and a software program capable of generating quickly an utterance from the current token value and the recorded digits before the token value expires.

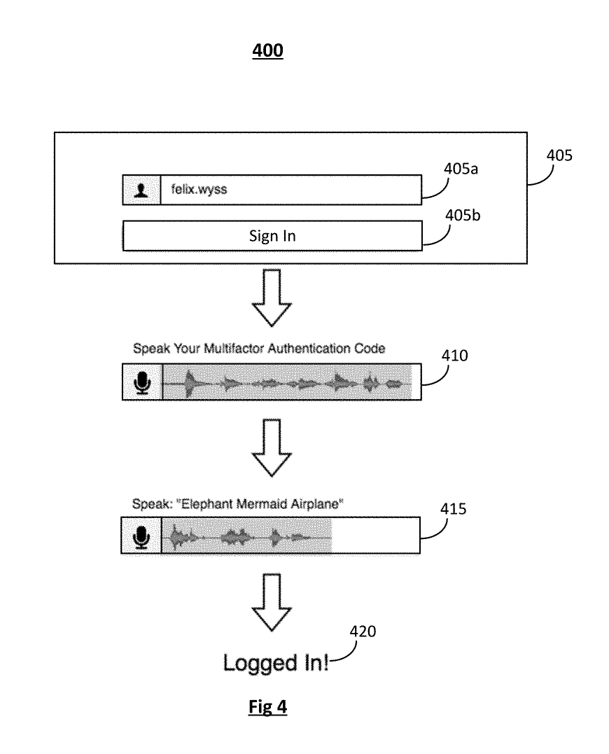

In another embodiment, the system may further prompt the user to speak a few words randomly selected from a large collection of words. FIG. 4 is a diagram illustrating an embodiment of a system protected with voice biometric verification as part of multi-factor authentication, indicated generally at 400. At sign-in, a user may be presented with a window 405 in a user interface comprising a space for entering a userID 405a and a sign-in button 410b. In an embodiment, a space for entering a passphrase in addition to the userID may also be present. The user enters their userID into the space at 405a, which in this example is ‘felix.wyss”. The user clicks “sign-in” at 405b. The system then takes the user to a screen prompt for speaking a multi-factor authentication code 410. The user accesses the digits of the multi-factor authentication code from a device, such as a smartphone or an application on another device, and speaks the digits to the system. The user may then be prompted to speak a few words randomly selected from a large collection of words 415. A user may be prompted to speak a few words randomly a plurality of times, in an embodiment, for more security or if the reading wasn't accurate due to background noise the first time. Poor ASR confidence may also trigger a repeat of prompts for the user to speak and/or a poor voice biometric confidence of a match. Furthermore, the prompt for a user speaking the multi-factor authentication code does not have to occur prior to the prompt to speak words. The prompt for a user speaking the multi-factor authentication code may occur after the prompt to speak words. The system verifies the user's identity through the process described in FIG. 2, and the verified user is then logged in 420.

Adding the step of prompting a user to speak randomly selected words makes it nearly impossible for an attacker to mount a replay attack as it would be infeasible to record the user speaking all possible words from the challenge collection. This step is helpful in a situation where an attacker within listening proximity to the user speaking the token value during the authentication step creates a separate authentication session with the system claiming to be the user. As the user speaks the token value, the attacker captures the genuine user's speech and immediately passes it on the attacker's session. If the system is suspicious by receiving identity claims from two sessions simultaneously or in the same multi-factor authentication token value update interval, the attacker would have to be able to temporarily suppress or delay the network packets from the authenticating user. If the system uses an additional random word challenge as described above, the genuine user's and the attacker's authentication session would receive a different randomly chosen set of challenge words. Even if the impostor could capture the token value in real-time, the challenge would fail. Challenge words may be selected for phonemic balance, distinctiveness, pronounceability, minimum length, and easy recognizability by the ASR system.

In another embodiment, the system could adaptively decide to perform the word challenge described above based on several criteria. For example, the criteria might comprise: the identity claim session originates from a different IP address than the last session, the identity claim session is from a new client of new browser instance (which may be tracked based on a cookie or similar persistent state stored in the client), no login has occurred for a specified interval of time, there are unusual login patterns (e.g., time of day, day of the week), there are unusually low confidence values in the voice match, there are several identity claim sessions for the same user in short succession, the system detects higher levels of background noise or background speech (which might indicate that the user is in an environment with other people present), and set for random intervals, to name several non-limiting examples.

In another embodiment, a user may speak their userID instead of being required to enter the userID in the form. The system may allow the user to speak their name as the identity claim.

In an embodiment, if the browser used by the user to access the system or application does not support capturing audio through WebAudio or WebRTC, or the computer has no microphone, the system could call the user once the user signs in. The call may be placed on a previously registered phone number to establish the audio channel. Using a previously registered phone number would add additional security as an imposter would have to steal the phone or otherwise change the phone number associated with the user account.

In yet another embodiment, if the system recognizes that the user is not who they claim they are, the system may frustrate the imposter by pretending not to understand them and indefinitely re-prompt for the multi-factor authentication value, random verification words, etc.

In yet another embodiment, a multi-factor authentication token may be used which is specifically designed for voice biometric application instead of the digit-based multi-factor authentication tokens currently in use. This token generates a set of words instead of digits as token value. For input through a keyboard or key-pad, numeric digit-based multi-factor authentication token values are more practical. To speak the token, a set of words can provide higher levels of security and ease-of-use. For example, a six-digit multi-factor authentication token value offers 1,000,000 possible values. Picking three words at random from a dictionary of 1000 words provides 1,000,000,000 possible combinations.

The embodiments disclosed herein may also have the added protection of user devices. For example, many users use multi-factor authentication applications (soft tokens) residing on their mobile devices. Many mobile devices use a fingerprint sensor to unlock the device for use. Thus, the user's fingerprint may be intrinsically coupled to the embodiments described herein as the fingerprint is needed to access the multi-factor authentication token along with the user's voice print to verify a user's identity. Furthermore, an implication is that the user is currently in physical possession of the device hosting the multi-factor authentication toke when speaking the authentication code.

In another embodiment, the authentication process may occur through a phone using an interactive voice response (IVR) system as opposed to a UI. The user may call into an IVR system using a device, such as a phone. The IVR system may recognize the number associated with the device the user is calling from and ask the user for a multi-factor authentication token value. If the system does not recognize the number the user is calling from, the system may ask the user for an identifier before proceeding with the authentication process.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the invention as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

1. A method for allowing a user access to a system through multi-factor authentication applying a voice biometric engine and an automatic speech recognition engine, the method comprising the steps of:
a. accessing, by the user, the software application through a first device, wherein the accessing triggers voice identification of the user;
b. initiating, by the system, an auditory interaction with the user;
c. prompting, by the system, the user to speak the current value generated by a security token, wherein the generated current value is accessed by the user from a second device;
d. capturing, by the system, voice of the user and feeding the voice into the automatic speech recognition engine and the voice biometric verification engine; and
e. allowing access to the software application if the user's identity is verified, otherwise denying access to the user.

2. The method of claim 1, wherein accessing comprises a user entering a user identifier in field in a user interface.

3. The method of claim 1, wherein accessing comprises a user speaking a user identifier, wherein the automatic speech recognition engine performs recognition on the user identifier.

4. The method of claim 1, wherein the auditory interaction is performed through a built-in microphone supported by the first device.

5. The method of claim 1, wherein the auditory interaction is made through a phone call initiated by the system to a previously registered phone number associated with the user's account.

6. The method of claim 1, wherein the first device comprises a computing device.

7. The method of claim 1, wherein the second device comprises a mobile device.

8. The method of claim 1, wherein the automatic speech recognition engine recognizes a digit sequence of the current value to verify that the user is in possession of the security token.

9. The method of claim 8, wherein the verifying is performed based on a confidence level of the automatic speech recognition engine, wherein a threshold is established for the confidence level of the automatic speech recognition engine, and the user is verified if the confidence level reaches the threshold.

10. The method of claim 1, wherein the voice biometric engine verifies the user based on a voice print confidence level reaching a threshold.

11. The method of claim 1, wherein the denying access further comprises the system raising the thresholds of at least one of the voice biometric engine and the automatic speech recognition engine to an inaccessible level, wherein the user is re-prompted indefinitely for the current value generated by the security token.

12. A method for allowing a user access to a system through multi-factor authentication using voice biometrics, the method comprising the steps of:
a. accessing, by the user, the software application through a device, wherein the accessing triggers voice identification of the user;
b. initiating, by the system, an auditory interaction with the user;
c. prompting, by the system, the user to speak a first desired phrase;
d. prompting by the system, the user to speak a second desired phrase;
e. capturing, by the system, voice of the user and concurrently feeding the voice into a automatic speech recognition engine and a voice biometric verification engine; and
f. allowing access to the software application if the user's identity is verified, otherwise denying access to the user.

13. The method of claim 12, wherein the first desired phrase comprises randomly selected words from a large collection of words and the second desired phrase comprises a current value generated by a multi-factor authentication token.

14. The method of claim 12, wherein the first desired phrase comprises a current value generated by a multi-factor authentication token and the second desired phrase comprises randomly selected words from a large collection of words.

15. The method of claim 13, wherein the randomly selected words are selected according at least of the following criteria: phonemic balance, distinctiveness, minimum length, pronounceability, and recognizability by the automatic speech recognition engine.

16. The method of claim 14, wherein the randomly selected words are selected according at least of the following criteria: phonemic balance, distinctiveness, minimum length, pronounceability, and recognizability by the automatic speech recognition engine.

17. The method of claim 12, wherein accessing comprises a user entering a user identifier in field in a user interface.

18. The method of claim 12, wherein accessing comprises a user speaking a user identifier, wherein the automatic speech recognition engine performs recognition on the user identifier.

19. The method of claim 12, wherein the auditory interaction is made through a built-in microphone supported by the user's device.

20. The method of claim 12, wherein the auditory interaction is made through a phone call initiated by the system to a previously registered phone number associated with the user's account.

21. The method of claim 12, wherein the device comprises one of: a computing device or a mobile device.

22. The method of claim 13, wherein the automatic speech recognition engine recognizes a digit sequence of the current value to verify that the user is in possession of the authentication token.

23. The method of claim 22, wherein the verifying is performed based on a confidence level of the automatic speech recognition engine, wherein a threshold is established for the confidence level of the automatic speech recognition engine, and the user is verified if the confidence level reaches the threshold.

24. The method of claim 13, wherein the voice biometric engine verifies the user based on a voice print confidence level reaching a threshold.

25. The method of claim 14, wherein the automatic speech recognition engine recognizes a digit sequence of the current value to verify that the user is in possession of the authentication token.

26. The method of claim 25, wherein the verifying is performed based on a confidence level of the automatic speech recognition engine, wherein a threshold is established for the confidence level of the automatic speech recognition engine, and the user is verified if the confidence level reaches the threshold.

27. The method of claim 14, wherein the voice biometric engine verifies the user based on a voice print confidence level reaching a threshold.

28. The method of claim 12, wherein the denying access further comprises the system raising the thresholds of at least one of the voice biometric engine and the automatic speech recognition engine to an inaccessible level, wherein the user is re-prompted indefinitely for the current value generated by the security token.
